(19) United States
(12) Patent Application Publication
(10) Pub. No.: US 2013/0231963 A1
(43) Pub. Date: Sep. 5, 2013

(54) METHOD OF MANAGING AN INSURANCE PLAN AND A SYSTEM THEREFOR

(71) Applicant: DISCOVERY HOLDINGS LIMITED, Sandton (ZA)

(72) Inventors: Adrian GORE, Sandton (ZA); Herschel Phillip MAYERS, Johannesburg (ZA)

(73) Assignee: DISCOVERY HOLDINGS LIMITED, Sandton (ZA)

(21) Appl. No.: 13/782,203

(22) Filed: Mar. 1, 2013

(30) Foreign Application Priority Data
Mar. 2, 2012 (ZA) 2012/01595

(51) Int. Cl. G06Q 40/08

(52) U.S. Cl. CPC G06Q 40/08
USPC 705/4

(57) ABSTRACT

An insurance plan implemented by a computer system receives an insured person's selection of an insured event and an insured amount to be paid on the occurrence of the insured event. Information is also received pertaining to an ancillary insured event and an ancillary amount to be paid on the occurrence of the ancillary insured event. Software calculates an increase in the ancillary amount to be paid on the occurrence of the ancillary insured event, the increase based on a ratio of the ancillary amount to the first insured amount. A premium is calculated using the first insured amount and the ancillary amount, and not the increase in the ancillary amount. Payment is made to the insured person if a first insured event has occurred, and is the increased ancillary payment amount if an ancillary insured event has occurred.

### BACKGROUND OF THE INVENTION

The present invention relates to a method of managing an insurance plan and a system therefor.

### SUMMARY

According to an example embodiment there is provided a system for managing an insurance plan, the system including:
a receiving module to receive an insured person's selection of a first insured event and a first insured amount to be paid on the occurrence of the first insured event, and an ancillary insured event and an ancillary amount to be paid on the occurrence of the ancillary insured event;
a calculation module for calculating an increase in the ancillary amount to be paid on the occurrence of the ancillary insured event, wherein the increase is based on the original ratio of the ancillary amount to the first insured amount, the calculation module further calculating a premium to be paid by the insured person wherein the premium is calculated using the selected first insured amount and the selected ancillary amount and not the increase in the ancillary amount;
at least one memory for storing therein insurance data for an insured person, the insurance data including data relating to the first insured event, the first insured amount, the ancillary insured event, the ancillary amount, the increased ancillary amount and the premium; and
a payment module to effect a payment to the insured person wherein the payment is the first insured amount if a first insured event has occurred and is the increased ancillary payment amount if an ancillary insured event has occurred.

According to another example embodiment there is provided a method of managing an insurance plan, the method including:
receiving an insured person's selection of a first insured event and a first insured amount to be paid on the occurrence of the first insured event, and an ancillary insured event and an ancillary amount to be paid on the occurrence of the ancillary insured event;
calculating an increase in the ancillary amount to be paid on the occurrence of the ancillary insured event, wherein the increase is based on the original ratio of the ancillary amount to the first insured amount, the calculation module further calculating a premium to be paid by the insured person wherein the premium is calculated using the selected first insured event and the selected ancillary amount and not the increase in the ancillary amount;
storing insurance data for an insured person, the insurance data including data relating to the first insured event, the first insured amount, the ancillary insured event, the an ancillary amount, the increased ancillary amount and the premium; and
paying an amount to the insured person wherein the payment is the first insured amount if a first insured event has occurred and is the increased ancillary payment amount if an ancillary insured event has occurred.

### BRIEF DESCRIPTION OF THE DRAWINGS

FIG. 1 is a block diagram illustrating an example system to implement the methodologies described herein; and

FIG. 2 is a block diagram illustrating an example embodiment method.

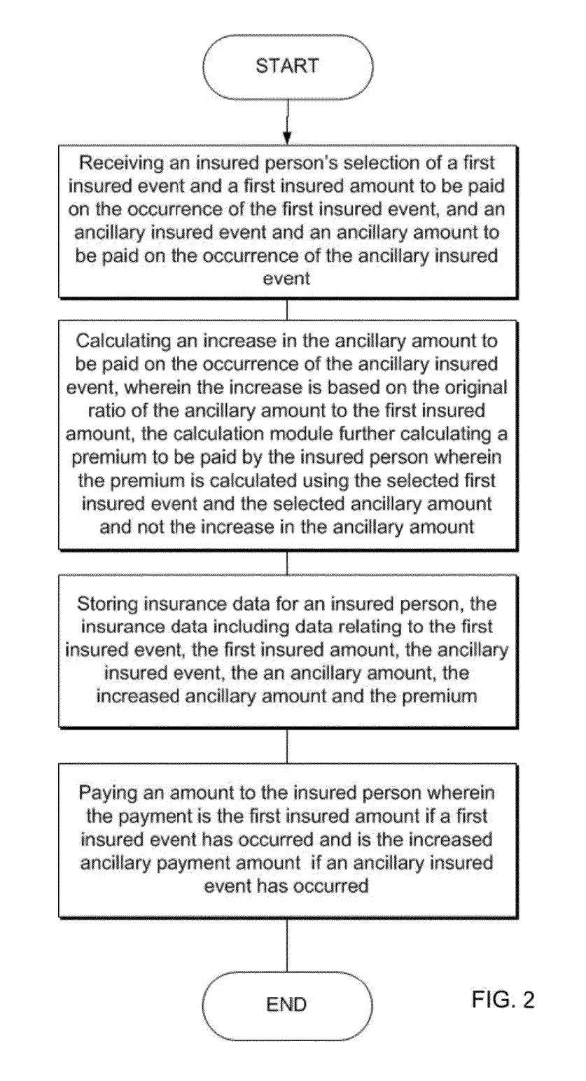

### DESCRIPTION OF EMBODIMENTS

The present invention relates to a method of managing an insurance plan and a system therefor.

In one example embodiment, the insurance plan includes life, disability and severe illness components and an insured person and/or their spouse may be covered under an insurance plan.

In this embodiment, the insurance plan is comprised of a main or first insured event and an ancillary insured event, possibly a number of ancillary insured events. The example illustrated below will refer to a first insured event being life insurance and the ancillary insured event being one or more of severe illness, disability, spouse life insurance, spouse severe illness and spouse disability.

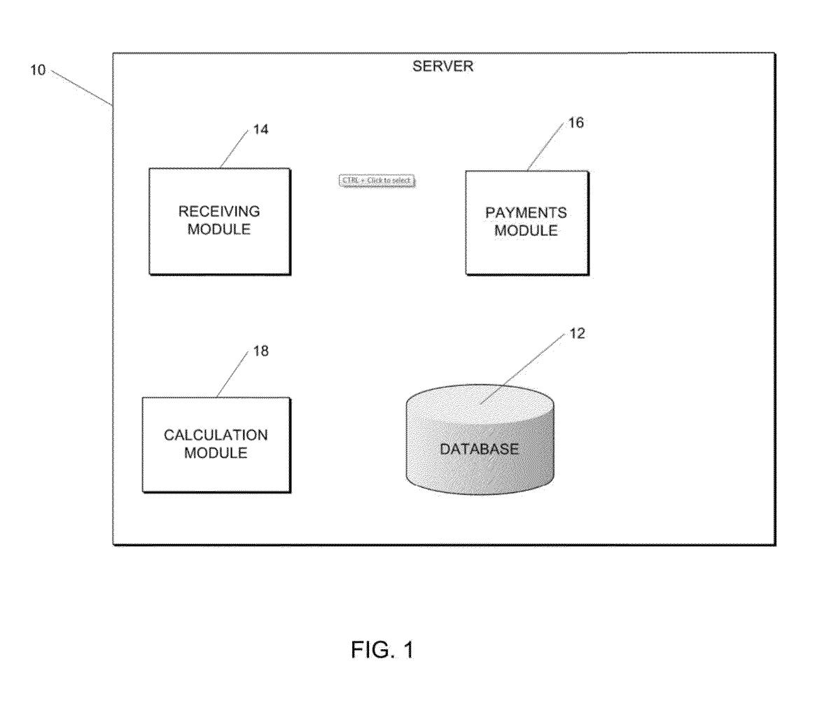

Referring to the accompanying Figures, a system to implement the present invention and the methodologies described below in one example embodiment includes a server 10 as shown in FIG. 1 together with a number of modules which are described below in more detail. These modules described below may be implemented by a machine-readable medium embodying instructions which, when executed by a machine, cause the machine to perform any of the methods described herein.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein. The claim data is received from an insured person either directly or through an intermediary.

In the illustrated embodiment, at least one memory 12 is used for storing therein insurance data for an insured person. The insurance data will be described in more detail below.

A receiving module 14 receives an insured person's selection of a first insured event and a first insured amount to be paid on the occurrence of the first insured event, and an ancillary insured event and an ancillary amount to be paid on the occurrence of the ancillary insured event.

A calculation module 18 then calculates an increase in the ancillary amount to be paid on the occurrence of the ancillary insured event, wherein the increase is based on the original ratio of the ancillary amount to the first insured amount.

In one embodiment the increase is only calculated if the ratio of the ancillary amount to the first insured amount is above a predetermined threshold.

The calculation module 18 further calculates a premium to be paid by the insured person wherein the premium is calculated using the selected first insured amount and the selected ancillary amount and not the increase in the ancillary amount.

The premium is paid from the insured person to the insurer in return for which the selected insurance is activated. On the occurrence of an insured event, the insurer pays the insured person an amount as will be described in more detail below.

The payment module 16 effects a payment to the insured person wherein the payment is the first insured amount if a first insured event has occurred and is the increased ancillary payment amount if an ancillary insured event has occurred. By increased ancillary payment it will be appreciated that this is the original ancillary amount plus the amount of the increase making a total of the increased ancillary payment.

It will be appreciated that while the above example refers to having only one ancillary component, the insured person may in fact have many ancillary components.

An example of the above is illustrated as follows, an insured person selects life insurance of 1,000,000 and an accelerated ancillary severe illness insurance of 800,000 and an accelerated ancillary disability benefit of 750,000.

If the calculation module left the scenario unchanged, then on the occurrence of a severe illness claim of 800,000, the life insurance amount available will be reduced to 200,000.

In this example, it will be appreciated that any severe illness claim will result in a much smaller amount available on a life benefit claim and a proportionately smaller amount available on a disability benefit claim despite the full premiums payable for these benefits prior to the claim.

However, based on the initial ratios between these the amount available on the severe illness benefit claim will be increased to compensate for the full premiums that were payable prior to the claim.

Examples of these are as follows:

| Severe Illness Benefit (Ben %) | Free Severe Illness Cover |
|---|---|
| 0% <= Ben % < 50% | 0.00% |
| 50% <= Ben % < 60% | 10.00% |
| 60% <= Ben % < 70% | 15.00% |
| 70% <= Ben % < 80% | 20.00% |
| 80% <= Ben % < 90% | 30.00% |
| 90% <= Ben % <= 100% | 40.00% |

The percentages in the first column refer to a percentage that the initial severe illness benefit is of the initiation life insurance.

In the example above, the insured life will therefore have an extra 30%×800,000=240,000 Free Severe Illness Cover which would have been received on occurrence of the severe illness claim.

Thus in the above example, on the occurrence of a severe illness before dying, the insured person will be paid 1,040,000 leaving a balance of 200,000 to be paid on death. If they do not have a severe illness before dying they will be paid 1,000,000 on dying. Thus it will be appreciated that if the principal life then dies R200 000 would be paid but if they had died before the Severe illness claim R1 000 000 would have been paid.

Other examples are as follows:

| Spouse Life Cover Benefit | |
|---|---|
| (Ben %) | Free Spouse Life Cover |
| 0% <= Ben % < 50% | 0.00% |
| 50% <= Ben % < 60% | 10.00% |
| 60% <= Ben % < 70% | 15.00% |
| 70% <= Ben % < 80% | 20.00% |
| 80% <= Ben % < 90% | 30.00% |
| 90% <= Ben % <= 100% | 40.00% |

| Spouse Severe Illness Benefit or | Free Spouse Severe Illness |
|---|---|
| Spouse Disability (Ben %) | Cover |
| 0% <= Ben % < 50% | 0.00% |
| 50% <= Ben % < 60% | 10.00% |
| 60% <= Ben % < 70% | 15.00% |
| 70% <= Ben % < 80% | 20.00% |
| 80% <= Ben % < 90% | 30.00% |
| 90% <= Ben % <= 100% | 40.00% |

In a more complex example:

A new policy on 1 May 2012 has a 1,000,000 life fund with:
75% Accelerated Capital Disability,
30% Accelerated Severe Illness Benefit (SIB),
95% Spouse Life Cover (SLC),
70% Accelerated Spouse Severe Illness Benefit (SSIB),

Will get additional benefits as follows on the various benefits:

| | Benefit | Benefit | | FreeCover |
|---|---|---|---|---|
| Benefit | % | Amount | FreeCover % | Amount |
| Principal | 100% | 1,000,000 | N/A | R0 |
| Life Cover | | | | |
| Capital | 75% | 750,000 | N/A | R0 |
| Disability | | | | |
| SIB | 30% | 300,000 | SIB % < 50%, so | 0% * 300,000 = |
| | | | Boost % = 0% | 0 |
| Spouse | 95% | 950,000 | SLC % >= 90% so | 40% * 950,000 = |
| Life Cover | | | Boost % = 40% | 380,000 |
| Spouse | 70% | 700,000 | 70% <= SSIB % < | 20% * 700,000 = |
| SIB | | | 80% so Boost % = | 140,000 |
| | | | 20% | |

In the above example, if the insured person's spouse suffers a severe illness, the person will be paid 840,000. If the insured person dies thereafter his estate will be paid out 300,000.

If after the insured person's spouse suffers a severe illness, the insured person also suffers a severe illness, he will be paid out 90,000 which is the balance of the original 1,000,000 less the 700,000 for his wife severe illness multiplied by the 30% benefit % for his severe illness cover with no additional benefit because his own severe illness is below the minimum amount for the free extra cover.

Thus it will be appreciated that an insured person with a policy with a high amount of ancillary cover will therefore have an extra amount of cover upfront for a claim for which he does not pay an explicit premium. The free cover is created through the construct of the other accelerated ancillary benefits on the insured's policy.

The terms and phrases used herein are not intended to be limiting, but rather, to provide an understandable description. Additionally, unless otherwise specifically expressed or clearly understood from the context of use, a term as used herein describes the singular or the plural of that term.

The terms “a” or “an”, as used herein, are defined as one or more than one. The term “plurality”, as used herein, is defined as two or more than two. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The term “communicatively coupled” or “communicatively coupling” includes, but is not limited to, communicating electronic control signals by which one element may direct or control another. The term “configured to” describes hardware, software or a combination of hardware and software that is adapted to, set up, arranged, commanded, altered, modified, built, composed, constructed, designed, or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “server”, “client”, “computer system”, “computing system”, “personal computing system”, or “processing system” describe examples of a suitably configured processing system adapted to implement one or more embodiments of the present disclosure. Any suitably configured processing system is similarly able to be used by embodiments of the present disclosure, for example and not for limitation, a personal computer, a laptop computer, a tablet computer, a personal digital assistant, a workstation, or the like. A processing system may include one or more processing systems or processors. A processing system can be realized in a centralized fashion in one processing system or in a distributed fashion where different elements are spread across several interconnected processing systems.

The terms “computing system”, “computer system”, and “personal computing system”, describe a processing system that includes a user interface and which is suitably configured and adapted to implement one or more embodiments of the present disclosure. The terms “network”, “computer network”, “computing network”, and “communication network”, describe examples of a collection of computers and devices interconnected by communications channels that facilitate communications among users and allows users to share resources.

The present subject matter can be realized in hardware, software, or a combination of hardware and software. A system can be realized in a centralized fashion in one computer system, or in a distributed fashion where different elements are spread across several interconnected computer systems. Any kind of computer system—or other apparatus adapted for carrying out the methods described herein—is suitable.

The present subject matter can also be embedded in a computer program product, which comprises all the features enabling the implementation of the methods described herein, and which—when loaded in a computer system—is able to carry out these methods. Computer program in the present context means any expression, in any language, code or notation, of a set of computer instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, computer instructions, messages or message packets, and other computer readable information from the computer readable medium. The computer readable medium may include computer readable storage medium tangibly embodying non-volatile memory, such as read-only memory (ROM), flash memory, disk drive memory, CD-ROM, and other permanent storage. Additionally, a durable non-transitory computer readable storage medium may include tangibly embodied volatile storage such as RAM, buffers, cache memory, and network circuits. Furthermore, according to various other embodiments, the computer readable medium may comprise computer readable information in a transitory state medium such as a network link and/or a network interface, including a wired network or a wireless network that allow a computer to read such computer readable information.

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

1. A system for managing an insurance plan, the system including:
a receiving module to receive an insured person's selection of a first insured event and a first insured amount to be paid on the occurrence of the first insured event, and an ancillary insured event and an ancillary amount to be paid on the occurrence of the ancillary insured event;
a calculation module for calculating an increase in the ancillary amount to be paid on the occurrence of the ancillary insured event, wherein the increase is based on the original ratio of the ancillary amount to the first insured amount, the calculation module further calculating a premium to be paid by the insured person wherein the premium is calculated using the selected first insured amount and the selected ancillary amount and not the increase in the ancillary amount;
at least one memory for storing therein insurance data for an insured person, the insurance data including data relating to the first insured event, the first insured amount, the ancillary insured event, the ancillary amount, the increased ancillary amount and the premium; and
a payment module to effect a payment to the insured person wherein the payment is the first insured amount if a first insured event has occurred and is the increased ancillary payment amount if an ancillary insured event has occurred.

2. A system according to claim 1 wherein the calculation module calculates that where an ancillary insured event has occurred before the first insured event, the first insured amount will be reduced.

3. A system according to claim 2 wherein the calculation module calculates that where an ancillary insured event has occurred before the first insured event, the first insured amount will be reduced by an amount smaller than the increased ancillary payment amount.

4. A system according to claim 1 wherein the calculation module calculates that where the first insured event has occurred before an ancillary insured event, the increased ancillary payment amount, including the ancillary amount, will be reduced to zero.

5. A method of managing an insurance plan, the method including:
using at least one computer executing software stored on non-transitory media, the software configured for—
receiving data pertaining to an insured person's selection of a first insured event and a first insured amount to be paid on the occurrence of the first insured event, and an ancillary insured event and an ancillary amount to be paid on the occurrence of the ancillary insured event;
calculating an increase in the ancillary amount to be paid on the occurrence of the ancillary insured event, wherein the increase is based on the original ratio of the ancillary amount to the first insured amount;
calculating a premium to be paid by the insured person wherein the premium is calculated using the selected first insured event and the selected ancillary amount and not the increase in the ancillary amount;
storing insurance data for an insured person, the insurance data including data relating to the first insured event, the first insured amount, the ancillary insured event, the an ancillary amount, the increased ancillary amount and the premium; and
causing a payment to be made to the insured person, wherein the payment is the first insured amount if a first insured event has occurred, and is the increased ancillary payment amount if an ancillary insured event has occurred.

6. A method according to claim 5 wherein where an ancillary insured event has occurred before the first insured event, the first insured amount will be reduced.

7. A method according to claim 6 wherein where an ancillary insured event has occurred before the first insured event, the first insured amount will be reduced by an amount smaller than the increased ancillary payment amount.

8. A method according to claim 5 wherein the calculation module calculates that where the first insured event has occurred before an ancillary insured event, the increased ancillary payment amount, including the ancillary payment amount, will be reduced to zero.
